(19) United States
(12) Patent Application Publication
(10) Pub. No.: US 2008/0037169 A1
(43) Pub. Date: Feb. 14, 2008

(54) IONIZING DEVICE FOR TAPE DRIVE SYSTEMS

(75) Inventors: Robert Glenn Biskeborn, Hollister, CA (US); Jason Liang, San Jose, CA (US)

Correspondence Address: ZILKA-KOTAB, PC, P.O. BOX 721120, SAN JOSE, CA, 95172-1120, US

(73) Assignee: INTERNATIONAL BUSINESS MACHINESS CORPORATION

(21) Appl. No.: 11/458,658

(22) Filed: Jul. 19, 2006

(51) Int. Cl. G11B 5/00

(52) U.S. Cl. 360/128

(57) ABSTRACT

A tape drive system includes a magnetic head, a drive mechanism for passing a magnetic tape over the head, and an ion generating device for providing ions in a vicinity of the tape, the ions being adsorbed onto the tape surface, which may include being absorbed by water on the tape. Ions dissolved in the water promote corrosion of metallic accumulations on the head.

### FIELD OF THE INVENTION

The present invention relates to tape drive systems, and more particularly, this invention relates to a tape drive system implementing an ionizing device.

### BACKGROUND OF THE INVENTION

Business, science and entertainment, applications depend upon computing systems to process and record data. In these applications, large volumes of data are often stored or transferred to nonvolatile storage media, such as magnetic discs, magnetic tape cartridges, optical disk cartridges, floppy diskettes, or floptical diskettes. Typically, magnetic tape is the most economical, convenient, and secure means of storing or archiving data.

Storage technology is continually pushed to increase storage capacity and storage reliability. Improvement in data storage densities in magnetic storage media, for example, has resulted from improved medium materials, improved error correction techniques and decreased area bit sizes. The data capacity of half-inch magnetic tape, for example, is currently measured in hundreds of gigabytes.

A magnetic tape is typically a multilayer structure including a base layer and a magnetically definable layer in which data is stored. The magnetically definable layer includes pure metal particles that define the magnetic transitions that represent data. In addition to encapsulation, binders, etc., the pure metal particles typically represent about 50% of the material in the magnetically definable layer.

One problem frequently encountered during reading and writing to tape is that the metal particles or fragments therefrom can come loose from the tape and adhere to the head, forming metallic bridges on the head. Another problem is formation of metallic bridges via electrostatic interaction with the head and involving the tape. Read sensors are particularly susceptible to failure due to shield-shorting as a result of bridging. Accumulation has been found to be particularly prevalent in low humidity conditions, e.g., less than about 20% relative humidity. Such low humidity conditions are typical with the current prevalence of air conditioned server rooms and business places.

The only known solutions to the bridging problem are to recess the sensor so that its components do not make electrical contact with the conductive accumulation, and/or to coat the head with a durable wear coating. In the former case, such a recessed sensor has not been implemented and is believed to be difficult to manufacture, and would also result in an undesirable spacing loss. The latter method is complex and expensive and the coatings may wear off over time, even with pre-recession.

There is accordingly a clearly-felt need in the art for a tape drive system that is less susceptible to shorting due to metallic accumulation on the head. It would he desirable to provide a solution that is inexpensive and reliable. These unresolved problems and deficiencies are clearly felt in the art and are solved by this invention in the manner described below.

### SUMMARY OF THE INVENTION

A tape drive system includes a magnetic head, a drive mechanism for passing a magnetic tape over the head, and an ion generating device for providing ions in a vicinity of the tape, the ions being adsorbed on the surface of the tape, which may include the ions being absorbed by water on the tape. In particular, ions in concert with the adsorbed water promote corrosion of metallic accumulations on the head. The corroded metal is not electrically conductive, and thus the frequency of shorting due to metallic formations on the head is reduced.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should he made to the following detailed description read in conjunction with the accompanying drawings.

FIG. 1 is a schematic diagram of the tape drive system.

FIG. 2 is a side view of an ion generating device according to an embodiment of the present invention.

FIG. 3 is a side view of an ion generating device according to an embodiment of the present invention.

FIG. 4 is a side view of an ion generating device according to an embodiment of the present invention.

FIG. 5 is a partial perspective view of an ion generating device according to an embodiment of the present invention.

FIG. 6 is a side view of an ion generating device according to an embodiment of the present invention.

FIG. 7 is a side view of an ion generating device according to an embodiment of the present invention.

FIG. 8 is a partial perspective view of an ion generating device according to an embodiment of the present invention.

### BEST MODE FOR CARRYING OUT THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

In the drawings, like and equivalent elements are numbered the same throughout the various figures.

The embodiments described below disclose a new tape drive system having an ion generating device for providing ions in a vicinity of the tape, the ions being adsorbed on the tape and carried to the head by the tape. The ions, particularly in concert with adsorbed water, promote corrosion of metallic accumulations on the head, especially such as from particles that break free from the tape passing over the head. The ionized water promotes corrosion of metal particles on the tape that may adhere to the head. The corroded particles are not electrically conductive, and thus shorting due to particles accumulated on the head is minimized.

In embodiments where iron-containing tape is used, the invention works by promoting the corrosion (oxidation) of iron films that form on the head. Corrosion of iron is also known as “rusting.” The iron is believed to come from fragments of magnetic particles in the magnetic definable layer of the tape. Another mechanism is growth of metallic bridges due to electric fields on the head and between the head and tape. By promoting oxidation of the iron film, shorting can be minimized and often eliminated. The invention is especially useful when drives run for an extended period of time at very low humidity, as will soon become apparent.

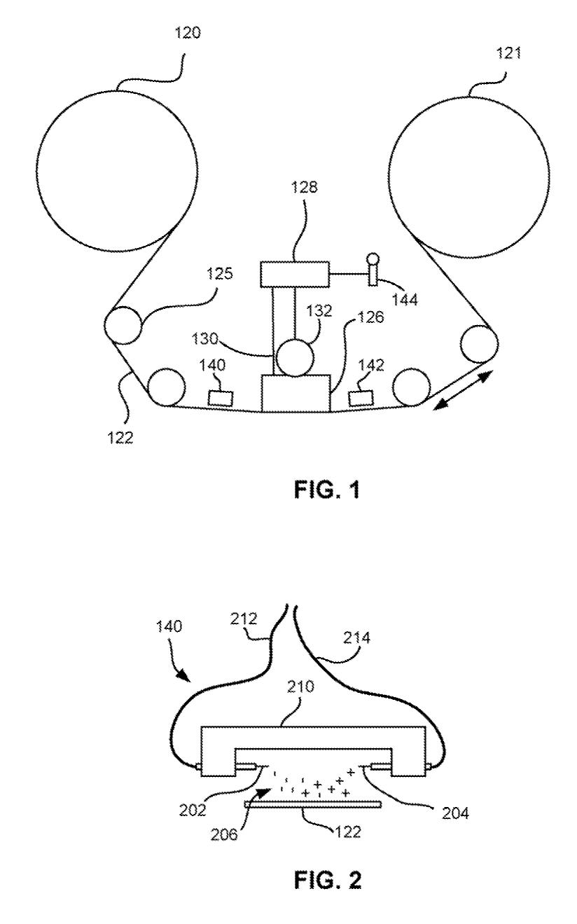

FIG. 1 illustrates a simplified tape drive system which may be employed in the context of the present invention. While one specific implementation of a tape drive system is shown in FIG. 1, it should be noted that the various embodiments described herein may be implemented in the context of any type of tape drive system.

As shown, a tape supply reel 120 and a take-up reel 121 are provided to support a magnetic recording tape 122. The tape supply reel 120 and take-up reel 121 may form part of a removable cassette and are not necessarily part of the system. Guides 125 guide the tape 122 across a tape head 126 of any type, including a bidirectional head, flat profile head, rounded profile head, etc. Such tape head 126 is in turn coupled to a controller assembly 128 via an MR connector cable 130. The controller 128, in turn, controls head functions such as track following, writing and read functions, etc. An actuator 132 controls position of the head 126 relative to the tape 122.

A tape drive system, such as that illustrated in FIG. 1, includes drive motor(s) to drive the tape supply cartridge 120 and the take-up reel 121 to move the tape 122 linearly over the head 126. The tape drive also includes a read/write channel to transmit data to the head 126 to be recorded on the tape 122 and to receive data read by the head 126 from the tape 122. An interface is also provided for communication between the tape drive and a host (integral or external) to send and receive the data and for controlling the operation of the tape drive and communicating the status of the tape drive to the host.

When using a tape drive system such as that shown in FIG. 1, humidity in the air promotes formation of a layer of water on the surface of the tape. Often, enough water becomes adsorbed to the tape to form a locally continuous film. This film in turn may absorb O₂, CO₂ and other gases from the atmosphere. Generally, the gases may contain ions, which also become absorbed. When water containing ions (i.e., conductive water) comes in contact, with a corrodible metal, such as that found in accumulations on the head, corrosion occurs. The pathway for this reaction may be as follows. Carbon dioxide dissolved in the adsorbed water may form a weak carbonic acid, which is a better electrolyte than pure water. The acid dissolves the iron and some of the water breaks down into hydrogen and oxygen. The free oxygen and dissolved iron react to form iron oxide, in the process freeing electrons. The electrons liberated from the anode portion of the iron (accumulated particles) flow to the cathode, which may be a piece of a metal less electrically reactive than iron, e.g., the head, or another point on the iron deposit itself. The result is that the iron is converted into rust. Rust is non-electrically conductive and so does not produce surface shorting on the heads.

The more water that is present on the tape, the more likely the metallic deposits on the head will corrode. The amount of water on the tape is proportional to the ambient relative humidity, where the relative humidity is the ratio of the amount of water vapor in the air at a given temperature to the maximum amount air can hold at the same temperature, expressed as a percentage. At very low humidity, e.g., less than about 20% relative humidity, the inventors have observed that accumulation of metallic bridges on the surface of the head begins. This is believed to be because the amount of water adsorbed on the surface of the tape is too small to produce an oxidation reaction. Without wishing to be bound by any theory, it is believed that when the amount of water on the tape is low, the ionic conductivity of the water is very low and so corrosion of the metal particles accumulated on the head is very limited.

To promote corrosion, the present invention dispenses ions in the vicinity of the tape, where they are absorbed by the water on the tape. The addition of ions to the water on the tape makes the water a better electrolyte than pure water, thereby speeding the process of rusting on iron and other forms of corrosion on other metals.

Referring again to FIG. 1, an ion generating device 140 is positioned near the tape 122. The ion generating device 140 dispenses ions in the vicinity of the tape 122, primarily in the form of ionized air. The ions become adsorbed on the tape surface.

While some embodiments contemplate dispensing ions far from the tape, the distance between the ion dispensing portion of the ion generating device 140 and the tape 122 is preferably small. The closer the dispensing portion is to the tape 122, the higher the concentration of ions at the tape and thus the higher the concentration of ions that become absorbed in the water on the tape 122. Additionally, by concentrating the ions near the tape surface, the total amount of ions generated can be minimized, which is preferable to avoid promoting corrosion of other components of the tape drive system. Accordingly, an illustrative distance between the point of distribution of ions and the tape surface is between about 0 microns (contact distribution) and about 5000 microns (˜5 millimeters).

A second ion generating device 142 may be provided to allow selective generation of ions upstream of the head 126. For instance, as the tape 122 travels from reel 120 to reel 121, the first ion generating device 140 may be active so that the ions are carried by the tape to the head 126. The second ion generating device 142 may be inactive at this time. When the tape 122 travels in the reverse direction from reel 121 to reel 120, the second ion generating device 142 may be active so that the ions are carried by the tape to the head 126. The first ion generating device 140 may be inactive at this time. The controller 128 or host device can control whether and when the ion generating devices 140, 142 operate.

The ion generating devices 140, 142 shown in FIG. 1 illustrate only two possible locations for the ion generating device. Other locations include between the guides 125, between a reel 120, 121 and a guide 125, closer or farther from the head 126, remote from the tape 122 but having a conduit for transporting ionized air to the vicinity of the tape, etc.

A humidity sensor 144 may also be present for measuring a relative humidity of the ambient air in the drive housing, in the tape cartridge, in the room where the tape drive system is present, etc. The output of the humidity sensor 144 may be used as a basis for controlling whether or not the ion generating devices 140, 142 operate at a given time. For example, when the humidity sensor 144 indicates that the relative humidity is above 50%, the ion generating devices may remain idle, as the layer of water on the tape may be sufficient to promote corrosion. When the humidity sensor 144 indicates that the relative humidity is below 50%, the ion generating devices 140, 142 may be operated during read or write operations. As a nonbinding rule of thumb, the ion generating devices 140, 142 should be operated during read or write operations when the relative humidity in the drive housing is below about 20% to about 30%.

There are many possible implementations of an ion generating device, any of which may be implemented in the system described above.

FIG. 2 illustrates an embodiment of an ionization device 140 according to the present invention where metallic electrode filaments 202, 204 with exposed tips of opposite polarities ionize the surrounding air molecules, thereby creating positive and negative ions 206 (represented by + and − symbols). Sufficient voltage is applied to the filaments 202, 204 to create ions at the tips, as is well known. A positive ion is an atom or molecule that has lost an electron. A negative ion is an atom or molecule that has gained an electron. These filaments 202, 204, or any other filament described herein, may be mounted in a hollow housing, between a pair of tape bearing posts, inside a roller bearing tape guide, etc.

In the embodiment shown, a nonconductive supporting bracket 210 supports the filaments 202, 204 that are coupled via wires 212, 214 to external circuitry that applies a voltage to the filaments 202, 204. The wind created by the moving tape 122 stirs the air surrounding the tape 122, resulting in some of the ionized air being absorbed, for example, by the water on the tape 122. In other words, the ions dissolve into the water on the tape 122.

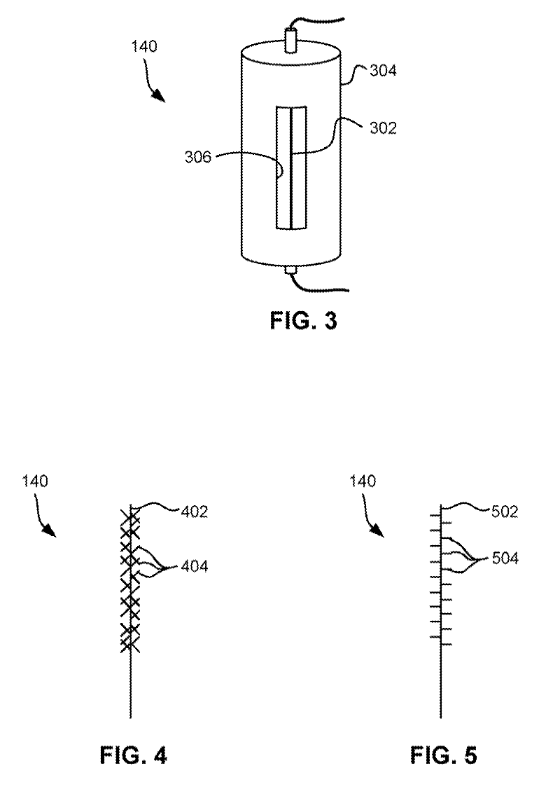

FIG. 3 illustrates an embodiment of an ion generating device 140 according to the present invention where a bare metallic filament 302 is positioned in a nonconductive or conductive hollow housing 304 with a window 306 therethrough that feces the tape. The hollow housing 304 protects the filament 302, and, the window 306 directs the ions towards the tape. If the housing 304 is grounded or positively or negatively charged, it may actively direct the ions out of the window 306. For example, where the housing 304 is grounded, some ions will go to ground, while others will be accelerated towards the tape. Two such housings may be present in the tape drive system in order to create both positive and negative ions. Alternatively, two filaments may be present to create both positive and negative ions in the housing.

FIG. 4 illustrates an embodiment of an ion generating device 140 according to the present invention where the filament 402 has many tips 404, the filament 402 resembling for example, a bottle brush. The tips would all have the same polarity, i.e., positive or negative. Having a large number of tips 404 produces a greater number of ions than a single tip. Again, two or more filaments may be provided, each having a different polarity,

FIG. 5 illustrates an embodiment of an ion generating device 140 according to the present invention where the filament 502 has many tips 504, the tips 504 being oriented generally along parallel planes. Again, two or more filaments may be provided, each having a different polarity.

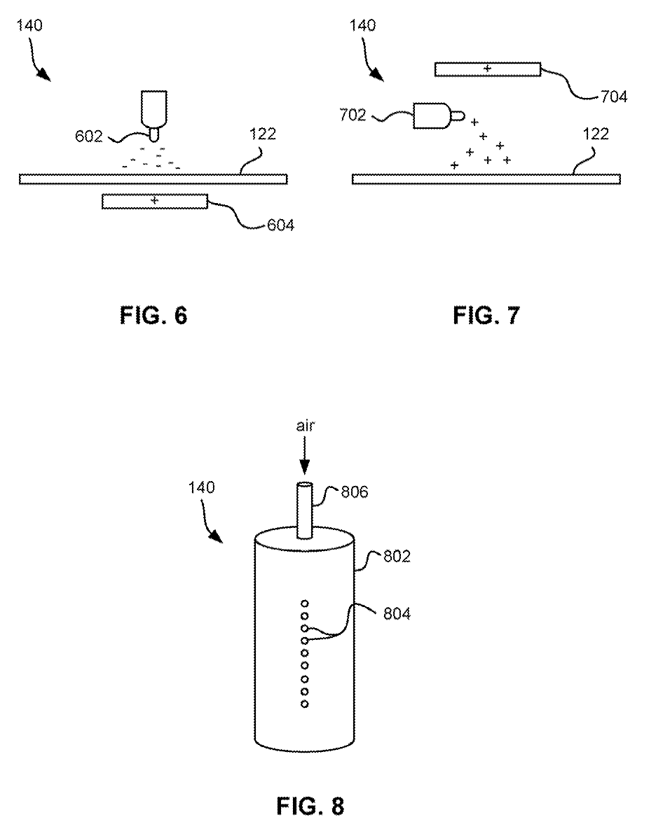

FIG. 6 illustrates an embodiment of an ion generating device 140 according to the present invention in which a charged filament 602 is positioned on one side of the tape 122 and an attracting surface 604 is positioned on the other side of the tape 122. The attracting surface 604 may be grounded, or positively or negatively charged such that the attracting surface 604 attracts the ions of opposite charge towards it. Thus, the ions are directly accelerated towards the tape surface. The attracting surface 604 can be a planar or rounded electrode, a wire mesh, etc. The attracting surface 604 may also be one of the tape guides.

FIG. 7 illustrates an embodiment of an ion generating device 140 according to the present invention in which a charged filament 702 is positioned between the tape 122 and a repelling surface 704. In this embodiment, the charge of the repelling surface 704 is such that the repelling surface 704 repels ions having the same charge away from it and towards the tape 122.

FIG. 8 illustrates an embodiment of an ion generating device 140 according to the present invention which includes a distributor 802 having one or a series of nozzles 804 (e.g., apertures, end of a tube, etc.). An air conduit 806 injects pressurized air into the distributor 802. The pressurized air exits the nozzles 804 at high velocity, carrying ions onto the tape surface. In one embodiment of the present invention, ionized air is generated remotely and sent through the distributor 802. In another embodiment of the present invention, the distributor 802 is conductive and the nozzles 804 are very small, e.g., less than about 25 microns in diameter. Ambient air, preferably containing CO₂ is pumped into the distributor 802, and the air exiting through the nozzles 804 picks up charge from the conductive distributor tube, thereby becoming ionized.

In another embodiment, oxygen and carbon dioxide gases are injected directly onto the tape to increase the oxygen and carbon dioxide content in the water on the tape. In this case the dissolved gases promote the corrosion process. Charging methods used in both inkjet and laser printing may be incorporated as well.

The various embodiments described herein, or portions thereof, can be used separately or in combination with one another. The invention may be used in combination with coated heads.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A tape drive system, comprising:
a magnetic head,
a drive mechanism for passing a magnetic tape over the head; and
an ion generating device for providing ions in a vicinity of the tape.

2. The system as recited in claim 1, wherein the ion generating device includes filaments with tips having opposite polarities,

3. The system as recited in claim 1, wherein the ion generating device includes a hollow housing and a filament therein, the hollow housing having a window facing the tape.

4. The system as recited in claim 3, wherein the hollow housing is set at a predetermined potential for accelerating the ions out of the window.

5. The system as recited in claim 1, wherein the ion generating device includes a filament having a plurality of tips, each of the tips having a same polarity.

6. The system as recited in claim 1, wherein the ion generating device includes a filament and, spaced therefrom, a grounded or charged surface, the surface being positioned on an opposite side of the tape as the filament, wherein the surface accelerates the ions towards the tape.

7. The system as recited in claim 1, wherein the ion generating device includes a filament and a grounded or charged surface, the filament being positioned between the surface and the tape, wherein the surface accelerates the ions towards the tape.

8. The system as recited in claim 1, wherein the ion generating device generates ionized air remotely from the tape, wherein a distributor distributes the ionized air in the vicinity of the tape.

9. The system as recited in claim 1, wherein the ion generating device includes a housing having multiple nozzles, wherein air passing through the nozzles becomes ionized, the nozzles directing the air towards the tape.

10. The system as recited in claim 1, further comprising a humidity sensor for determining a relative humidity of ambient air.

11. The system as recited in claim 1, wherein the ions absorbed by the water on the tape contact the head, wherein the ionized water promotes corrosion of metal particles accumulated on the head.

12. A tape drive system, comprising:
a magnetic head,
a drive mechanism for passing a magnetic tape over the head; and
an ion generating device for providing ions in a vicinity of the tape, the ions being adsorbed on the tape, the ions being carried to the head by the tape, wherein the ions in concert with the water promote corrosion of metallic accumulations on the head.

13. The system as recited in claim 12, wherein the ion generating device includes a single filament with tips having opposite polarities.

14. The system as recited in claim 12, wherein the ion generating device includes a hollow housing and a filament therein, the hollow housing having a window facing the tape.

15. The system as recited in claim 14, wherein the hollow housing is set at a predetermined potential for accelerating the ions out of the window.

16. The system as recited in claim 12, wherein the ion generating device includes a filament having a plurality of tips, each of the tips having a same polarity.

17. The system as recited in claim 12, wherein the ion generating device includes a filament and a grounded or charged surface, the surface accelerating the ions towards the tape.

18. The system as recited in claim 12, wherein the ion generating device generates ionized air remotely from the tape, wherein a distributor transports the ionized air to the vicinity of the tape.

19. The system as recited in claim 12, wherein the ion generating device includes a housing having multiple nozzles, wherein air passing through the nozzles becomes ionized, the nozzles directing the air towards the tape.

20. A method for promoting corrosion of metallic particles on a tape head, comprising:
generating ions in a vicinity of a magnetic tape, the ions being operatively transported by the tape to a tape head.
